(19) United States
(12) Patent Application Publication
(10) Pub. No.: US 2022/0262551 A1
(43) Pub. Date: Aug. 18, 2022

(54) SILICON OXIDE-COATED Fe-BASED SOFT MAGNETIC POWDER AND METHOD FOR PRODUCING SAME

(71) Applicant: DOWA ELECTRONICS MATERIALS CO., LTD., Tokyo (JP)

(72) Inventors: Yorito NISHIZAWA, Tokyo (JP); Koji TANOUE, Tokyo (JP)

(21) Appl. No.: 17/628,295

(22) PCT Filed: Aug. 26, 2020
(86) PCT No.: PCT/JP2020/032136

§ 371 Date: Jan. 19, 2022

(30) Foreign Application Priority Data
Aug. 30, 2019 (JP) 2019-158334

(51) Int. Cl. H01F 1/147; H01F 41/00; B22F 1/16; B22F 1/052

(52) U.S. Cl. CPC H01F 1/147; H01F 41/00; B22F 2302/256; B22F 1/052; B22F 2301/35; B22F 1/16

(57) ABSTRACT

Silicon oxide-coated Fe-based soft magnetic powder having a high insulation capability can be obtained in such a manner that Fe-based soft magnetic powder is dispersed in a mixed solvent of water and an alcohol having a Hansen solubility parameter (SP value) of 11.3 or less, containing 5% by mass or more and 50% by mass or less of water, so as to provide a slurry. Then, a silicon alkoxide and a hydrolysis catalyst for the silicon alkoxide are added to the slurry to coat a silicon oxide thereon. The silicon oxide-coated Fe-based soft magnetic powder is capable of providing a powder compact having a high volume resistivity in molding into a powder compact. A method of producing the same is also disclosed.

### TECHNICAL FIELD

The present invention relates to silicon oxide-coated Fe-based soft magnetic powder that has a good insulation capability, and is suitable for the production of powder compact magnetic cores of electric and electronic components, such as an inductor, a choke coil, a transformer, a reactor, and a motor, and a method for producing the same.

### BACKGROUND ART

A powder compact magnetic core formed of Fe-based soft magnetic powder, such as iron powder, alloy powder containing iron, and intermetallic compound powder, has been known as a magnetic core of an inductor, a choke coil, a transformer, a reactor, a motor, and the like. However, the powder compact magnetic core using the Fe-based soft magnetic powder containing the iron has a lower electric resistivity than a powder compact magnetic core using ferrite, and therefore is produced in such a manner that an insulating film is coated on the surface of the Fe-based soft magnetic powder, followed by compression molding and heat treatment.

Various insulating coating films have been proposed, and a silicon oxide film has been known as a highly insulating coating film. As Fe-based soft magnetic powder coated with a silicon oxide by a wet method, for example, PTL 1 describes a method for forming a silica film on soft magnetic powder for a powder compact magnetic core by dissolving a Si alkoxide in water, and then coating a hydrolysate of the Si alkoxide contained in the solution on the surface of soft magnetic powder containing iron as a major component, and a method for producing a powder compact magnetic core using the soft magnetic powder. In the method for forming a silica film, a silica film is formed on the surface of soft magnetic powder containing Fe as a major component, with a hydrolysis solution containing TEOS, isopropanol (IPA) as an organic solvent, an alkali, and water, and having concentrations of TEOS and water regulated to the prescribed values. The soft magnetic powder containing iron as a major component coated with the hydrolysate of TEOS is heat-treated during compression molding or after compression molding, and thereby the hydrolysate of TEOS is converted to a silica film having a high insulation capability.

PTL 2 describes soft magnetic powder for the purpose of a powder compact magnetic core, including Fe-based soft magnetic powder having a particle diameter of approximately 50 μm, having coated on the surface thereof a silica-based insulating film containing a silicone resin and a Si alkoxide, and a production method therefor. In the production method, a silicone resin is dissolved in IPA as a solvent, then TEOS as a Si alkoxide is added to the solution, followed mixing by agitation, and then an acid catalyst and water are added to the solution to provide a silica sol-gel coating liquid.

### CITATION LIST

### Patent Literatures

PTL 1: JP 2009-231481 A
PTL 2: JP 2017-183681 A

### SUMMARY OF INVENTION

### Technical Problem

However, in the coating methods of a silicon-based oxide described in PTL 1 and PTL 2, TEOS is hydrolyzed in IPA in advance, and fine particles of the hydrolysate of TEOS thus formed are adhered to the surface of the Fe-based soft magnetic powder, so as to form the silicon-based oxide film, and therefore the resulting silicon-based oxide film has many defects, and is difficult to achieve a high volume resistivity in molding into a powder compact.

Under the circumstances, the present applicant has applied, as Japanese Patent Application No. 2019-025026, soft magnetic powder coated with a silicon oxide having a high insulation capability, capable of providing a high volume resistivity in molding into a powder compact, and a method for producing the same. In the production method, soft magnetic powder containing iron in an amount of 20% by mass or more is dispersed in advance in a mixed solvent obtained by mixing water and an organic solvent, and after adding a silicon alkoxide to the slurry, a hydrolysis catalyst for the silicon alkoxide is added to cause hydrolysis reaction of the silicon alkoxide on the surface of the soft magnetic powder, resulting in a silicon oxide film having less defects.

In the invention described in Japanese Patent Application No. 2019-025026, the target soft magnetic powder is fine soft magnetic powder having a volume-based cumulative 50% particle diameter D₅₀ obtained by a laser diffraction particle size distribution measurement method of 1.0 μm or more and 5.0 μm or less, and a powder compact magnetic core formed of soft magnetic powder having the size is applied to such purposes as an inductor. As a result of earnest investigations by the present inventors, it has been found that the invention has room for improvement in the case where the production method of the invention is applied to Fe-based soft magnetic powder having a volume-based cumulative 50% particle diameter D₅₀ obtained by a laser diffraction particle size distribution measurement method of more than 5 μm and 200 μm or less, which is generally used for a powder compact magnetic core for such purposes as a coil of a motor and a reactor.

In view of the problem described above, an object of the present invention is to provide silicon oxide-coated Fe-based soft magnetic powder excellent in insulation capability and a method for producing the same, by favorably coating a silicon oxide on the surface of Fe-based soft magnetic powder having a relatively large particle diameter with D₅₀ of more than 5 μm and 200 μm or less.

### Solution to Problem

For achieving the object, the present invention provides

(1) silicon oxide-coated Fe-based soft magnetic powder including Fe-based soft magnetic powder as core particles, having provided on a surface thereof a silicon oxide coating layer having an average thickness of 1 nm or more and 80 nm or less, having a volume-based cumulative 50% particle diameter D₅₀ obtained by a laser diffraction particle size distribution measurement method of more than 5 μm and 200 μm or less, providing a powder compact obtained by pressing at 12.73 MPa having a volume resistivity measured by a concentric ring probe method of 1.0×10⁴ Ω·cm or more.

The present invention also provides

(2) silicon oxide-coated Fe-based soft magnetic powder including Fe-based soft magnetic powder as core particles, having provided on a surface thereof a silicon oxide coating layer having an average thickness of 1 nm or more and 80 nm or less, having a volume-based cumulative 50% particle diameter D₅₀ obtained by a laser diffraction particle size distribution measurement method of more than 5 μm and 200 μm or less, having a coverage rate R defined below of 0.8 or more,

R: in an X-ray photoelectron spectroscopy (XPS) measurement of elements other than oxygen of the silicon oxide-coated Fe-based soft magnetic powder, a proportion of a molar fraction of Si with respect to a total of molar fractions of elements other than oxygen.

(3) In the silicon oxide-coated Fe-based soft magnetic powder according to the items (1) and (2), the volume-based cumulative 50% particle diameter D₅₀ obtained by a laser diffraction particle size distribution measurement method is preferably 20 μm or more and 200 μm or less.

The present invention also provides

(4) a method for producing silicon oxide-coated Fe-based soft magnetic powder including Fe-based soft magnetic powder, having coated on a surface thereof a silicon oxide having an average thickness of 1 nm or more and 80 nm or less, including a step of mixing an alcohol having a Hansen solubility parameter at 25° C. (SP value) of 11.3 or less and water to prepare a mixed solvent containing 5% by mass or more and 50% by mass or less of water; a dispersing step of adding Fe-based soft magnetic powder having a volume-based cumulative 50% particle diameter D₅₀ obtained by a laser diffraction particle size distribution measurement method of more than 5 μm and 200 μm or less, to the mixed solvent, so as to provide a slurry having dispersed therein the Fe-based soft magnetic powder; an adding step of adding a silicon alkoxide and a hydrolysis catalyst for the silicon alkoxide to the slurry having dispersed therein the Fe-based soft magnetic powder, so as to provide a slurry having dispersed therein the Fe-based soft magnetic powder coated with a silicon oxide; a step of subjecting the slurry having dispersed therein the Fe-based soft magnetic powder coated with a silicon oxide to solid-liquid separation, so as to provide Fe-based soft magnetic powder coated with a silicon oxide; and a step of drying the Fe-based soft magnetic powder coated with a silicon oxide.

(5) In the item (4), the volume-based cumulative 50% particle diameter D₅₀ is preferably 20 μm or more and 200 μm or less.

(6) In the item (4), the slurry in performing the adding step preferably has a temperature of 10° C. or more and 70° C. or less.

(7) In the item (4), the slurry in performing the adding step more preferably has a temperature of 20° C. or more and 70° C. or less.

(8) The silicon oxide-coated Fe-based soft magnetic powder obtained by the production method of the item (4) preferably has a volume-based cumulative 50% particle diameter D₅₀ obtained by a laser diffraction particle size distribution measurement method of more than 5 μm and 200 μm or less.

(9) The silicon oxide-coated Fe-based soft magnetic powder obtained by the production method of the item (4) more preferably has a volume-based cumulative 50% particle diameter D₅O obtained by a laser diffraction particle size distribution measurement method of 20 μm or more and 200 μm or less.

### Advantageous Effects of Invention

The use of the production method of the present invention enables the production of silicon oxide-coated Fe-based soft magnetic powder excellent in insulation capability.

### DESCRIPTION OF EMBODIMENTS

### [Fe-based Soft Magnetic Powder]

In the present invention, Fe-based soft magnetic powder containing 20% by mass or more of iron is used as a starting material. The Fe-based soft magnetic powder may be pure iron powder or may contain at least one kind selected from the group consisting of Si, Cr, Al, Ni, Mo, Co, P, and B as an additional constitutional element. Specific examples of the Fe-based soft magnetic powder include iron powder, an Fe—Si alloy, an Fe—Si—Cr alloy, an Fe—Al—Si alloy (Sendust), and an Fe—Ni alloy having a permalloy composition (mass proportion of Ni: 30 to 80% by mass). These materials may contain a small amount (10% by mass or less) of Mo and Co depending on necessity. An alloy having Mo added thereto has a crystal structure becoming amorphous, and thus may be referred to as amorphous powder. The Fe-based soft magnetic powder is preferably iron powder, an Fe—Si alloy, an Fe—Si—Cr alloy, or an Fe—Al—Si alloy (in these alloys, the proportion of iron is preferably 85 to 98% by mass, and more preferably 90 to 98% by mass), from the standpoint of the favorable applicability thereof to the method for producing silicon oxide-coated Fe-based soft magnetic powder of the present invention.

In the description herein, the soft magnetic powder that is encompassed in the aforementioned definition may be referred simply to as “Fe-based soft magnetic powder” unless otherwise indicated. In the present invention, the magnetic characteristics of the Fe-based soft magnetic powder are not particularly determined, and powder having a low coercive force (Hc) and a high saturation magnetization (as) is preferred. The value of Hc is preferably as low as possible, and is preferably 3.98 kA/m (approximately 50 (Oe)) or less. A value of Hc that exceeds 3.98 kA/m may not be suitable for a magnetic core in some cases since the energy loss in reversal of the magnetic field is increased.

The value of as is preferably as high as possible, and is preferably 100 Am²/kg (100 emu/g) or more. A value of as that is less than 100 Am²/kg may not be preferred in the case where the size reduction of the magnetic core is intended since a large amount of the magnetic powder is required, which necessarily leads the increase in size of the magnetic core.

In the present invention, the Fe-based soft magnetic powder has a volume-based cumulative 50% particle diameter D₅₀ obtained by a laser diffraction particle size distribution measurement method of more than 5 μm and 200 μm or less. The cumulative 50% particle diameter D₅₀ of the Fe-based soft magnetic powder is preferably 6 μm or more and 200 μm or less, more preferably 20 μm or more and 200 μm or less, and further preferably 40 μm or more and 160 μm or less.

### [Silicon Oxide Coating Layer]

In the present invention, a silicon oxide having an insulation capability is coated on the surface of the particles constituting the Fe-based soft magnetic powder by a wet coating method using a silicon alkoxide. The coating method using a silicon alkoxide is generally referred to as a sol-gel method, and is excellent in mass production capability as compared to a dry method.

In hydrolysis of a silicon alkoxide, a part or the whole of the alkoxy group is substituted by a hydroxy group (OH group) to provide a silanol derivative. In the present invention, while the surface of the Fe-based soft magnetic powder is coated with the silanol derivative, the silanol derivative coated on the surface forms a polysiloxane structure through condensation or polymerization under heating, and the polysiloxane structure becomes silica (SiO₂) under further heating. In the present invention, the coating films of from the silanol derivative coating film having a part of the alkoxy group remaining, which is an organic material, to the silica film are generically referred to as a silicon oxide film.

The silicon alkoxide used may be a silicon alkoxide having an alkoxy group having 2 to 5 carbon atoms, such as triethoxysilane, tetraethoxysilane, tripropoxysilane, tetrapropoxysilane, tributoxysilane, tetrabutoxysilane, and pentyltriethoxysilane, in which tetraethoxysilane (TEOS) or tetrapropoxysilane (TPOS) is preferred, and the use of TPOS is more preferred, from the standpoint of the formation of a uniform silicon oxide layer and the achievement of a coating layer having high resistance.

### [Thickness]

In the present invention, the average thickness of the silicon oxide coating layer is 1 nm or more and 80 nm or less, and more preferably 5 nm or more and 65 nm or less. In the case where the thickness is less than 1 nm, a large amount of defects may exist in the coating layer, which makes it difficult to secure the insulation capability in some cases. In the case where the thickness exceeds 80 nm, the insulation capability is enhanced, but the powder compact density of the Fe-based soft magnetic powder may be decreased to deteriorate the magnetic characteristics in some cases. The average thickness of the silicon oxide coating layer may be measured by the dissolution method, and the details of the measurement method will be described later. In the case where the thickness is difficult to measure by the dissolution method, the average thickness may be obtained by observing the cross section of the silicon oxide coating layer with a transmission electron microscope (TEM) or a scanning electron microscope (SEM). In this case, a TEM photograph or an SEM photograph of the cross section is taken, and the average thickness can be obtained from the average value of 50 measuring points of an arbitrary particle. It has been confirmed that the average thickness of the silicon oxide coating layer that is obtained by measuring the cross section, which is obtained by cutting the silicon oxide-coated Fe-based soft magnetic powder with a focused ion beam (FIB) processing equipment, with a transmission electron microscope (TEM) matches, with high accuracy, the thickness that is obtained by the dissolution method described later with the assumption that the density of the silicon oxide coating layer is d=2.65 (g/cm³).

### [Coverage Rate R]

In the present invention, the silicon oxide-coated Fe-based soft magnetic powder preferably has a coverage rate R defined below of 0.8 or more.

R: In an X-ray photoelectron spectroscopy (XPS) measurement of elements other than oxygen of the silicon oxide-coated Fe-based soft magnetic powder, a proportion of a molar fraction of Si with respect to a total of molar fractions of elements other than oxygen

The silicon oxide-coated Fe-based soft magnetic powder of the present invention has the silicon oxide coating favorably formed thereon, resulting in few portions where the Fe-based soft magnetic powder as the core particles is exposed, and thus has a high coverage rate R as described above. The coverage rate R is more preferably 0.85 or more, further preferably 0.9 or more, and particularly preferably 0.95 or more, from the standpoint of the achievement of the excellent insulation capability due to the favorable silicon oxide film. The upper limit of the coverage rate R is 1.

### [Volume-based Cumulative 50% Particle Diameter]

In the present invention, the volume-based cumulative 50% particle diameter D₅₀ obtained by a laser diffraction particle size distribution measurement method of the silicon oxide-coated Fe-based soft magnetic powder is more than 5 μm and 200 μm or less. A particle diameter of 5 μm or less is not preferred since the magnetic characteristics (magnetic permeability) of the powder compact magnetic core are lowered, and a particle diameter of more than 200 μm is not preferred since the magnetic loss is increased due to the influence of the eddy current occurring inside the particles. From the same standpoint, the cumulative 50% particle diameter D₅₀ of the silicon oxide-coated Fe-based soft magnetic powder is preferably 6 μm or more and 200 μm or less, more preferably 20 μm or more and 200 μm or less, and further preferably 40 μm or more and 160 μm or less.

### [Powder Compact Density]

In the present invention, the powder compact density of the silicon oxide-coated Fe-based soft magnetic powder is not particularly determined, and is preferably 4.0 g/cm³ or more, and further preferably 5.0 g/cm³ or more. The powder compact density influences the magnetic permeability of the powder compact magnetic core. A low powder compact density is not preferred from the standpoint of the size reduction of the powder compact magnetic core since the magnetic permeability of the powder compact magnetic core is lowered, resulting in increase of the size of the powder compact magnetic core for providing the prescribed magnetic permeability.

### [Application]

The powder compact magnetic core produced with the silicon oxide-coated Fe-based soft magnetic powder of the present invention is favorably applied to such purposes as electric and electronic components, such as an inductor, a choke coil, a transformer, a reactor, and a motor.

The powder compact density is preferably as high as possible, and the upper limit of the powder compact density that is substantially obtained from the composition of the Fe-based soft magnetic powder is approximately 7 g/cm³.

### [Mixed Solvent and Dispersing Step]

One of the features of the production method of the present invention is the dispersing step provided for dispersing the Fe-based soft magnetic powder in a mixed solvent of water and an organic solvent by agitating with a known mechanical measure in advance before coating a silicon oxide on the surface of the Fe-based soft magnetic powder by a sol-gel method.

The Fe-based soft magnetic powder has on the surface thereof an extremely thin oxide of Fe, which is the major component of the Fe-based soft magnetic powder, and it is considered that a concentrated layer of water is formed on the surface of the Fe-based soft magnetic powder through the mutual interaction of the oxide of Fe and water molecules contained in the mixed solvent, and the Fe oxide undergoes hydration reaction. The surface of the hydrated Fe oxide is a type of a solid acid, and functions as a Bronsted acid showing a behavior similar to a weak acid, and therefore in the addition of a silicon alkoxide to the slurry containing the Fe-based soft magnetic powder in the mixed solvent in the next step, the reactivity between the silanol derivative as the hydrolysate of the silicon alkoxide and the surface of the Fe-based soft magnetic powder is enhanced.

The organic solvent used in the mixed solvent is preferably an alcohol having a Hansen solubility parameter at 25° C. (which may be hereinafter referred simply to as an SP value) of 11.3 or less. An alcohol having an SP value exceeding 11.3 is not preferred since the reactivity of water in the mixed solvent is lowered due to the high affinity of the solvent with water. In the present invention, the lower limit of the SP value is not particularly determined, and may be practically 9.0 or more, and preferably 10.3 or more, since a smaller SP value decreases the solubility of water in the alcohol. The Hansen solubility parameter at 25° C. (SP value) may be calculated according to a Hansen solubility parameter application software (Hansen Solubility Parameters in Practice (HSPiP) Ver.5.1.05, developers: Dr. Hansen, Prof. Abbott, Dr. Yamamoto).

The SP values of monohydric alcohols are exemplified below, and in the mixed solvent in the present invention, 1-butanol, 2-butanol (sec-butanol), 2-methyl-1-propanol (isobutanol), 2-methyl-2-propanol (t-butanol), 1-pentanol, 2-pentanol, isopentanol, t-pentanol, or the like are preferably used.

Methanol (SP value: 14.4, hereinafter the same), ethanol (13.0), 2-propanol (isopropyl alcohol, IPA) (11.5), 1-butanol (11.3), 2-butanol (10.8), 2-methyl-1-propanol (11.1), 2-methyl-2-propanol (10.6), 1-pentanol (10.7), 2-pentanol (10.5), isopentanol (10.4), t-pentanol (10.3)

The content of water in the mixed solvent is preferably 5% by mass or more and 50% by mass or less, and more preferably 5% by mass or more and 20% by mass or less. In the case where the content of water is less than 5% by mass, the hydration function of the Fe oxide described above may be short. In the case where the content of water exceeds 50% by mass, the hydrolysis rate of the silicon alkoxide is increased to fail to provide the uniform silicon oxide coating layer. Therefore, both the cases are not preferred.

The amount relative to liquid of the Fe-based soft magnetic powder with respect to the mixed solvent is preferably 5 to 50 parts by mass, more preferably 5 to 20 parts by mass, of water per 100 parts by mass of the Fe-based soft magnetic powder.

In the present invention, the temperature in the dispersing step (i.e., the temperatures of the mixed solvent for dispersing the Fe-based soft magnetic powder and the mixed liquid (slurry) after dispersing) is not particularly determined, and is preferably 10° C. or more and 70° C. or less. In the case where the temperature is less than 10° C., the rate of the hydration reaction of the Fe oxide may be lowered in some cases. In the case where the temperature exceeds 70° C., the hydrolysis reaction rate of the silicon alkoxide added in the subsequent alkoxide adding step may be increased, and the uniformity of the silicon oxide coating layer (i.e., the fewness of the portions where the particles of the Fe-based soft magnetic powder as the core are not coated with the silicon oxide but are exposed) may be deteriorated in some cases. From these standpoints, the temperature of the dispersing step is more preferably 20° C. or more and 70° C. or less. In the present invention, the period of time for retaining the slurry under agitation in the dispersing step is also not particularly determined, and the condition may be appropriately selected to make a retention time of 1 minute or more and 30 minutes or less for performing the hydration reaction of the Fe oxide uniformly.

### [Alkoxide Adding Step]

The silicon alkoxide is added to the slurry containing the Fe-based soft magnetic powder dispersed in the mixed solvent obtained in the preceding dispersing step, under agitation with a known mechanical measure, and then the slurry is retained in this state for a certain period of time. As described above, the silicon alkoxide used may be a silicon alkoxide having 2 to 5 carbon atoms, such as triethoxysilane, tetraethoxysilane, tripropoxysilane, tetrapropoxysilane, tributoxysilane, tetrabutoxysilane, and pentyltriethoxysilane, and tetraethoxysilane (TEOS) or tetrapropoxysilane (TPOS) is preferred.

The order of the alkoxide adding step and the hydrolysis catalyst adding step described later may be reversed, and these two steps may be performed simultaneously.

The substantially whole amount of the silicon alkoxide added in this step is used for the formation of the silicon oxide coating layer, and therefore the amount thereof added may be an amount corresponding to an average thickness of 1 nm or more and 80 nm or less of the silicon oxide coating layer. The amount of the silicon alkoxide added may be specifically determined in the following manner.

Assuming that the mass of the Fe-based soft magnetic powder contained in the slurry is Gp (g), the BET specific surface area of the Fe-based soft magnetic powder before coating is S (m²/g), and the target thickness of the silicon oxide coating layer is t (nm), the total volume of the silicon oxide coating layer is V=Gp×S×t (10⁻⁵ m³), and assuming that the density of the silicon oxide coating layer is d=2.65 (g/cm³=10⁶ g/m³), the mass of the silicon oxide coating layer is Gc=0.1V×d (g). Accordingly, the molar number of Si contained in the silicon oxide coating layer can be obtained as a value obtained by dividing Gc by 60.08, which is the molecular weight of SiO₂. In the production method of the present invention, the silicon alkoxide in a molar amount corresponding to the target thickness t (nm) is added to the slurry containing the Fe-based soft magnetic powder dispersed in the mixed solvent.

In the present invention, the temperature of the slurry in performing the alkoxide adding step is not particularly determined, and is preferably 10° C. or more and 70° C. or less. In the case where the temperature is less than 10° C., the reaction rate of the surface of the Fe-based soft magnetic powder and the silanol derivative may be lowered in some cases. In the case where the temperature exceeds 70° C., the hydrolysis reaction rate of the silicon alkoxide added may be increased, and the uniformity of the silicon oxide coating layer may be deteriorated in some cases. From these standpoints, the temperature of the slurry is more preferably 20° C. or more and 70° C. or less. In the present invention, the period of time of the alkoxide adding step (i.e., the period of time for reacting the silanol derivative formed and the surface of the Fe-based soft magnetic powder) is also not particularly determined, and the condition may be appropriately selected to make a period of time of 10 minutes or less for performing the reaction of the surface of the Fe-based soft magnetic powder and the silanol derivative uniformly.

### [Hydrolysis Catalyst Adding Step]

In the production method of the present invention, after forming the reaction layer of the silanol derivative on the surface of the Fe-based soft magnetic powder in the alkoxide adding step described above, a hydrolysis catalyst for the silicon alkoxide is added to the slurry containing the Fe-based soft magnetic powder dispersed in the mixed solvent, under agitation with a known mechanical measure. The order of the addition of the alkoxide and the addition of the hydrolysis catalyst may be reversed, and these two steps may be performed simultaneously, as described above.

In this step, the addition of the hydrolysis catalyst accelerates the hydrolysis reaction of the silicon alkoxide, and the film formation rate of the silicon oxide coating layer is increased. The process after this step may be the same procedures as the film forming method by the ordinary sol-gel method.

The hydrolysis catalyst used is preferably an alkali catalyst. An acid catalyst used may dissolve Fe as the constitutional component in the soft magnetic powder in some cases. The alkali catalyst is preferably aqueous ammonia since impurities are difficult to remain in the silicon oxide coating layer, and aqueous ammonia is easily available.

In the present invention, the temperature of the slurry in performing the hydrolysis catalyst adding step is not particularly determined, and may be the same as the temperature of the slurry in performing the alkoxide adding step. In the present invention, the period of time of the hydrolysis catalyst adding step (i.e., the period of time for adding the hydrolysis catalyst to form the silicon oxide coating layer on the surface of the Fe-based soft magnetic powder) is also not particularly determined, and the condition may be appropriately selected to make a period of time of 5 minutes or more and 120 minutes or less since a prolonged reaction time is economically disadvantageous.

### [Solid-Liquid Separation and Drying]

From the slurry containing the silicon oxide-coated Fe-based soft magnetic powder obtained through the series of steps described above, the silicon oxide-coated Fe-based soft magnetic powder is recovered with a known solid-liquid separation measure. The solid-liquid separation measure used may be a known solid-liquid separation measure, such as filtration, centrifugal separation, and decantation. The solid-liquid separation may be performed with a flocculant added.

The silicon oxide-coated Fe-based soft magnetic powder thus recovered is dried preferably in an air atmosphere at a temperature of 80° C. or more. The drying at 80° C. or more can decrease the water content of the silicon oxide-coated Fe-based soft magnetic powder to 0.25% by mass or less. The drying temperature is preferably 85° C. or more, and more preferably 90° C. or more. The drying temperature is preferably 400° C. or less, and more preferably 150° C. or less, for preventing the silicon oxide coating layer from being released. In the case where the soft magnetic powder is suppressed from being oxidized, the powder may be dried in an inert gas atmosphere or a vacuum atmosphere.

### [Measurement of Si Content]

The content of Si in the silicon oxide-coated Fe-based soft magnetic powder is measured by the weight method (dissolution method). Hydrochloric acid and perchloric acid are added to the specimen, which are heated for decomposition, and heated until white smoke of perchloric acid occurs. Subsequently, the specimen is heated to dryness. After spontaneously cooling, water and hydrochloric acid are added thereto and heated to dissolve soluble salts. The undissolved residue is filtered with filter paper, and the residue is placed in a crucible along with the filter paper, and dried and incinerated. After spontaneously cooling, the residue is weighed along with the crucible. Small amounts of sulfuric acid and hydrofluoric acid are added thereto, and the mixture is heated to dryness and then ignited. After spontaneously cooling, the residue is weighed along with the crucible. The second weighed value is subtracted from the first weighed value, and the Si content is calculated assuming that the weight difference is the weight of SiO₂.

### [Calculation of Average Thickness of Silicon Oxide Coating Layer]

Assuming that the Si content of the silicon oxide-coated Fe-based soft magnetic powder measured by the aforementioned method (dissolution method) is A (% by mass), the mass proportion B (% by mass) of the silicon oxide coating layer is calculated from the atomic weight of Si and the molecular weight of SiO₂ according to the following expression.

B=A×(molecular weight of SiO₂)/(atomic weight of Si)=A×60.08/28.09

The average thickness t (nm) of the silicon oxide coating layer is expressed by the following expression with S (m²/g) and d (g/cm³) described above. In the following expression, the numeral 10 is the conversion factor.

t(nm)=10×B/(d×S)

The average thickness of the silicon oxide coating layer calculated with the assumption that the value of d is 2.65 g/cm³ well matches the TEM observation result, as described above.

### [Measurement of BET Specific Surface Area]

The BET specific surface area is measured with a BET specific surface area measuring equipment (Macsorb, produced by Mountech Co., Ltd.) in such a manner that the measuring equipment is purged with nitrogen gas at 105° C. for 20 minutes and then evacuated for removing attachments and the like on the surface of the powder, and then the BET specific surface area is measured by the BET 1-point method under a flow of a mixed gas of nitrogen and helium (N2: 30% by volume, He: 70% by volume).

### [Measurement of Volume Resistivity]

The volume resistivity of the silicon oxide-coated Fe-based soft magnetic powder is measured with a powder resistance measuring unit (MCP-PD51), produced by Mitsubishi Chemical Analytech Co., Ltd., a high resistance resistivity meter, Hiresta UP (MCP-HT450), produced by Mitsubishi Chemical Analytech Co., Ltd., or a low resistance resistivity meter, Loresta (MCP-T610), produced by Mitsubishi Chemical Analytech Co., Ltd., and a powder resistivity measuring system (Hiresta), produced by Mitsubishi Chemical Analytech Co., Ltd., or a powder resistivity measuring system (Loresta), produced by Mitsubishi Chemical Analytech Co., Ltd., in such a manner that 4.0 g of the powder is vertically pressed at 12.73 MPa (4 kN), and measured under application of voltage. For Comparative Examples 1 and 2 (low resistance) described later, the volume resistivity was measured by the four-probe method with Loresta and a powder resistivity measuring system (Loresta), and for Examples 1 to 3 (high resistance) described later, the volume resistivity was measured by the concentric ring probe method with Hiresta UP and a powder resistivity measuring system (Hiresta).

The volume resistivity at 12.73 MPa (4 kN) is preferably 1.0×10⁴ Ω·cm or more, more preferably 1.0×10⁶ Ω·cm or more, and particularly preferably 1.0×10⁷ Ω·cm or more. The upper limit thereof may be 1.0×10¹² Ω·cm.

### [Laser Diffraction Particle Size Distribution Measurement]

The particle size distributions of the Fe-based soft magnetic powder before coating and after the silicon oxide coating treatment are measured with a laser diffraction particle size distribution measuring equipment (HELOS particle size distribution measuring equipment (HELOS & RODOS), produced by Sympatec GmbH). The focal length of the measurement lens is 200 mm. The cumulative 10% particle diameter (D₁₀), the cumulative 25% particle diameter (D₂₅), the cumulative 50% particle diameter (D₅₀), the cumulative 75% particle diameter (D₇₅), the cumulative 90% particle diameter (D₉₀), and the cumulative 99% particle diameter (D₉₉), which are all volume based, are obtained by the equipment, and the cumulative 50% particle diameter (D₅₀) is designated as the average particle diameter.

### [XPS Measurement]

The XPS measurement is performed with PHI 5800 ESCA System, produced by Ulvac-Phi, Inc. The analyzed area is 800 μm in diameter, with X-ray source: Al tube, power of X-ray source: 150 W, cumulated number: 20, analysis angle: 45°, vacuum degree of sample chamber: 10⁻⁸ Pa or less. In the measurement, a photoelectron spectrum is firstly obtained through wide scan (in a range of binding energy of 0 to 1,000 eV), and then measurements through narrow scan are performed corresponding to the prescribed orbitals of the elements (except for oxygen) detected in the wide scan. The background processing is performed by the Shirley method. The molar fractions of the elements in determining the coverage rate R are calculated from the integrated value ratios corresponding to the prescribed orbitals of the elements in the photoelectron spectrum obtained in the narrow scan after performing relative sensitivity correction on the analysis software. The photoelectron spectrum on the outermost surface of the particles is measured after preforming sputter etching with Ar ion for the powder specimen.

### EXAMPLES

### Example 1

120 g of isobutyl alcohol (IBA, Hansen SP value at 25° C.: 11.3) and 21 g of pure water were placed in a 300 mL reaction vessel at room temperature, and mixed with an agitation blade at 850 rpm to prepare a mixed solvent, and then 75 g of pure Fe powder (O₂: 0.096% by mass, Si: 0.00% by mass, BET specific surface area: 0.096 m²/g, D₅₀: 101.7 μm, volume resistivity: 1.1×10⁻² Ω·cm) as Fe-based soft magnetic powder was added to the mixed solvent, so as to provide a slurry having the pure Fe powder dispersed therein. Thereafter, the upper space of the reaction vessel was charged with nitrogen gas for nitrogen purge, and the oxygen concentration in the space was confirmed to be zero with an oxygen meter. The slurry was heated from room temperature to 40° C. over 15 minutes under agitation at an agitation rate of 850 rpm. In this case, the retention time of the slurry in the dispersing step was 15 minutes.

To the slurry having the pure Fe powder dispersed in the mixed solvent under agitation, 2.80 g of tetraethoxysilane (TEOS, guaranteed reagent, produced by Wako Pure Chemical Industries, Ltd.) taken in a small beaker was added at one time. TEOS attached to the small beaker was washed off with 5 g of IBA and added to the reaction vessel. After adding TEOS, the agitation was continued for 5 minutes to perform the reaction between the hydrolysate of TEOS and the surface of the Fe-based soft magnetic powder.

Subsequently, to the slurry retained for 5 minutes after the addition of TEOS, 12.9 g of 28% by mass aqueous ammonia was added over 45 minutes. After completing the addition of aqueous ammonia, the slurry was retained for 90 minutes under agitation for ripening the reaction product, so as to form a silicon oxide coating layer on the surface of the pure Fe powder.

Thereafter, the slurry was filtered with a pressure filtering device to provide a cake of magnetic powder. The cake of magnetic powder was dried at 100° C. in the air for 10 hours, and then cracked with a sieve of 500 μm mesh, so as to provide silicon oxide-coated pure Fe powder.

In the XPS measurement of the resulting silicon oxide-coated pure Fe powder, peaks of Si and O were observed, from which it was confirmed that the powder was coated with a silicon oxide. The same was applied to the following examples. More specifically, while the elements assumed to be contained in the silicon oxide-coated pure Fe powder were Fe, O, Si, and C (i.e., C derived from TEOS), the wide scan measurement revealed that the peak of Fe (binding energy in a range of 700 to 750 eV) and the peak of C (binding energy in a range of 270 to 300 eV) were observed but were extremely small, and the peak of Si (binding energy in a range of 90 to 120 eV) and the peak of O (binding energy in a range of 520 to 540 eV) were observed. Furthermore, no other peak was observed in the wide scan measurement, from which it was considered that (the surface of the particles of) the silicon oxide-coated pure Fe powder contained substantially no impurity.

The narrow scan measurement was then performed for Si, Fe, and C. In the resulting photoelectron spectrum, scan was performed for the 2p3/2 orbital of Si (binding energy in a range of 105 to 110 eV), the 2p3/2 orbital of Fe (binding energy in a range of 710 to 720 eV), and the is orbital of C (binding energy in a range of 285 to 290 eV), and the peaks were observed.

The molar fractions of the elements were obtained from the observation results. The molar fractions of the elements were calculated from the integrated value ratios of the peaks of the elements after performing relative sensitivity correction on the analysis software. As a result, assuming that the total molar fraction of Fe, C, and Si was 100% by mol, the molar fraction of Fe was 0.2% by mol, the molar fraction of C was 1.0% by mol, and the molar fraction of Si was 98.8% by mol. From these results, the coverage rate R of the resulting silicon oxide-coated pure Fe powder was 0.988.

The resulting silicon oxide-coated pure Fe powder was measured for the particle size distribution, the BET specific surface area, and the volume resistivity of the powder compact. The production condition of the silicon oxide-coated pure Fe powder is shown in Table 1, and the property values (including the coverage rate R) of the resulting silicon oxide-coated pure Fe powder and the pure Fe powder before coating the silicon oxide are shown in Table 2.

### Examples 2 and 3

In Example 2, silicon oxide-coated pure Fe powder was obtained in the same procedure as in Example 1 except that TEOS added to the slurry was changed to 3.60 g of TPOS. In Example 3, silicon oxide-coated pure Fe powder was obtained in the same procedure as in Example 1 except that TEOS added to the slurry was changed to 3.60 g of TPOS, and the ripening time was changed to 150 minutes. The production condition of the silicon oxide-coated pure Fe powder of Examples 2 and 3 is shown in Table 1, and the property values of the resulting silicon oxide-coated pure Fe powder measured in the same manner as in Example 1 are shown in Table 2.

### Comparative Examples 1 and 2

In Comparative Examples 1 and 2, silicon oxide-coated pure Fe powder was obtained in the same manner as in Examples 1 and 2 respectively except that the alcohol added to the mixed solvent was changed from IBA to IPA (Hansen SP value at 25° C.: 11.5) in an amount of 120 g in the preparation and 5 g for washing. The production condition of the silicon oxide-coated pure Fe powder of Comparative Examples 1 and 2 is shown in Table 1, and the property values of the resulting silicon oxide-coated pure Fe powder measured in the same manner as in Example 1 are shown in Table 2.

It is understood from Examples and Comparative Examples that the use of the mixed solvent containing an alcohol having a Hansen SP value at 25° C. of 11.3 or less and the dispersing step defined in the present invention can provide the silicon oxide-coated Fe-based soft magnetic powder capable of providing a powder compact having a high volume resistivity in molding into a powder compact.

TABLE 1

| | | | | Catalyst | Ripening | Reaction | Drying |
|---|---|---|---|---|---|---|---|
| | | Silicon | Hydrolysis | adding time | time | temperature | temperature |
| | Alcohol | alkoxide | catalyst | (min) | (min) | (° C.) | (° C.) |
| Example 1 | IBA | TEOS | NH₃ | 45 | 90 | 40 | 100 |
| Example 2 | IBA | TPOS | NH₃ | 45 | 90 | 40 | 100 |
| Example 3 | IBA | TPOS | NH₃ | 45 | 150 | 40 | 100 |
| Comparative | IPA | TEOS | NH₃ | 45 | 90 | 40 | 100 |
| Example 1 | | | | | | | |
| Comparative | IPA | TPOS | NH₃ | 45 | 90 | 40 | 100 |
| Example 2 | | | | | | | |

TABLE 2

| | BET | | Thickness | | | | | | | | |
|---|---|---|---|---|---|---|---|---|---|---|---|
| | specific | Si | of silicon | | | | | | | | |
| | surface | content | oxide | | | | | | | | Volume |
| | area | (% by | coating | Coverage | Particle size distribution (μm) | | | | | | resistivity |
| | (m²/g) | mass) | layer (nm) | rate R | D₁₀ | D₂₅ | D₅₀ | D₇₅ | D₉₀ | D₉₉ | (Ω · cm) |
| Pure Fe | 0.096 | 0 | 0 | 0 | 46 | 70 | 102 | 136 | 168 | 225 | 1.1 × 10⁻² |
| powder | | | | | | | | | | | |
| Example 1 | 0.182 | 0.5 | 40 | 0.988 | 48 | 72 | 103 | 137 | 170 | 238 | 2.9 × 10⁷ |
| Example 2 | 0.560 | 0.5 | 40 | 0.987 | 47 | 70 | 100 | 134 | 166 | 224 | 1.9 × 10⁸ |
| Example 3 | 0.422 | 0.5 | 40 | 0.989 | 58 | 83 | 113 | 145 | 176 | 244 | 1.6 × 10⁷ |
| Comparative | 0.168 | 0.4 | 40 | 0.600 | 53 | 77 | 107 | 140 | 171 | 225 | 1.9 × 10² |
| Example 1 | | | | | | | | | | | |
| Comparative | 0.076 | 0.3 | 40 | 0.680 | 45 | 67 | 98 | 132 | 165 | 233 | 2.3 × 10² |
| Example 2 | | | | | | | | | | | |

### Example 4

120 g of isobutyl alcohol (IBA, Hansen SP value at 25° C.: 11.3) and 21 g of pure water were placed in a 300 mL reaction vessel at room temperature, and mixed with an agitation blade at 850 rpm to prepare a mixed solvent, and then 75 g of pure Fe powder different from that used in Example 1 and the like (O₂: 0.9% by mass, Si: 0.00% by mass, BET specific surface area: 0.669 m²/g, D₅₀: 6.28 μm, volume resistivity: 5.2 Ω·cm) as Fe-based soft magnetic powder was added to the mixed solvent, so as to provide a slurry having the pure Fe powder dispersed therein. Thereafter, the upper space of the reaction vessel was charged with nitrogen gas for nitrogen purge, and the oxygen concentration in the space was confirmed to be zero with an oxygen meter. The slurry was heated from room temperature to 40° C. over 15 minutes under agitation at an agitation rate of 850 rpm. In this case, the retention time of the slurry in the dispersing step was 15 minutes.

To the slurry having the pure Fe powder dispersed in the mixed solvent under agitation, 3.40 g of tetraethoxysilane (TEOS, guaranteed reagent, produced by Wako Pure Chemical Industries, Ltd.) taken in a small beaker was added at one time. TEOS attached to the small beaker was washed off with 5 g of IBA and added to the reaction vessel. After adding TEOS, the agitation was continued for 5 minutes to perform the reaction between the hydrolysate of TEOS and the surface of the Fe-based soft magnetic powder.

Subsequently, to the slurry retained for 5 minutes after the addition of TEOS, 12.9 g of 28% by mass aqueous ammonia was added over 45 minutes. After completing the addition of aqueous ammonia, the slurry was retained for 90 minutes under agitation for ripening the reaction product, so as to form a silicon oxide coating layer on the surface of the pure Fe powder.

Thereafter, the slurry was filtered with a pressure filtering device to provide a cake of magnetic powder. The cake of magnetic powder was dried at 100° C. in the air for 10 hours, and then cracked with a sieve of 500 μm mesh, so as to provide silicon oxide-coated pure Fe powder. The production condition of the powder is shown in Table 3, and the property values thereof measured in the same manner as in Example 1 are shown in Table 4.

### Example 5

In Example 5, silicon oxide-coated pure Fe powder was obtained in the same procedure as in Example 4 except that TEOS added to the slurry was changed to (4.30) g of TPOS. The production condition of the powder is shown in Table 3, and the property values thereof measured in the same manner as in Example 1 are shown in Table 4.

### Comparative Example 3

In Comparative Example 3, silicon oxide-coated pure Fe powder was obtained in the same manner as in Example 4 except that the alcohol added to the mixed solvent was changed from IBA to IPA (120 g in the preparation and 5 g for washing). The production condition of the powder is shown in Table 3, and the property values thereof measured in the same manner as in Example 1 are shown in Table 4.

TABLE 3

| | | | | Catalyst | Ripening | Reaction | Drying |
|---|---|---|---|---|---|---|---|
| | | Silicon | Hydrolysis | adding time | time | temperature | temperature |
| | Alcohol | alkoxide | catalyst | (min) | (min) | (° C.) | (° C.) |
| Example 4 | IBA | TEOS | NH₃ | 45 | 90 | 40 | 100 |
| Example 5 | IBA | TPOS | NH₃ | 45 | 90 | 40 | 100 |
| Comparative | IPA | TEOS | NH₃ | 45 | 90 | 40 | 100 |
| Example 3 | | | | | | | |

TABLE 4

| | BET | | Thickness | | | | | | | | |
|---|---|---|---|---|---|---|---|---|---|---|---|
| | specific | Si | of silicon | | | | | | | | |
| | surface | content | oxide | | | | | | | | Volume |
| | area | (% by | coating | Coverage | Particle size distribution (μm) | | | | | | resistivity |
| | (m²/g) | mass) | layer (nm) | rate R | D₁₀ | D₂₅ | D₅₀ | D₇₅ | D₉₀ | D₉₉ | (Ω · cm) |
| Pure Fe | 0.669 | 0.0 | 0 | 0 | 2.13 | 3.76 | 6.28 | 9.54 | 13.31 | 21.42 | 5.2 × 10⁰ |
| powder | | | | | | | | | | | |
| Example 4 | 1.353 | 0.6 | 5 | 0.989 | 2.43 | 4.04 | 6.53 | 9.73 | 13.49 | 21.62 | 1.7 × 10⁷ |
| Example 5 | 2.306 | 0.6 | 5 | 0.986 | 2.38 | 4.02 | 6.54 | 9.74 | 13.50 | 21.62 | 3.3 × 10⁸ |
| Comparative | 0.926 | 0.6 | 5 | 0.780 | 2.27 | 3.91 | 6.44 | 9.68 | 13.44 | 21.54 | 1.4 × 10⁶ |
| Example 3 | | | | | | | | | | | |

1. Silicon oxide-coated Fe-based soft magnetic powder comprising Fe-based soft magnetic powder as core particles, having provided on a surface thereof a silicon oxide coating layer having an average thickness of 1 nm or more and 80 nm or less, having a volume-based cumulative 50% particle diameter D₅₀ obtained by a laser diffraction particle size distribution measurement method of more than 5 μm and 200 μm or less, providing a powder compact obtained by pressing at 12.73 MPa having a volume resistivity measured by a concentric ring probe method of 1.0×10⁴ Ω·cm or more.

2. Silicon oxide-coated Fe-based soft magnetic powder comprising Fe-based soft magnetic powder as core particles, having provided on a surface thereof a silicon oxide coating layer having an average thickness of 1 nm or more and 80 nm or less, having a volume-based cumulative 50% particle diameter D₅₀ obtained by a laser diffraction particle size distribution measurement method of more than 5 μm and 200 μm or less, having a coverage rate R defined below of 0.8 or more,
R: in an X-ray photoelectron spectroscopy (XPS) measurement of elements other than oxygen of the silicon oxide-coated Fe-based soft magnetic powder, a proportion of a molar fraction of Si with respect to a total of molar fractions of elements other than oxygen.

3. The silicon oxide-coated Fe-based soft magnetic powder according to claim 1, wherein the volume-based cumulative 50% particle diameter D₅₀ is 20 μm or more and 200 μm or less.

4. A method for producing silicon oxide-coated Fe-based soft magnetic powder including Fe-based soft magnetic powder, having coated on a surface thereof a silicon oxide having an average thickness of 1 nm or more and 80 nm or less, comprising
a step of mixing an alcohol having a Hansen solubility parameter at 25° C. (SP value) of 11.3 or less and water to prepare a mixed solvent containing 5% by mass or more and 50% by mass or less of water;
a dispersing step of adding Fe-based soft magnetic powder having a volume-based cumulative 50% particle diameter D₅₀ obtained by a laser diffraction particle size distribution measurement method of more than 5 μm and 200 μm or less, to the mixed solvent, so as to provide a slurry having dispersed therein the Fe-based soft magnetic powder;
an adding step of adding a silicon alkoxide and a hydrolysis catalyst for the silicon alkoxide to the slurry having dispersed therein the Fe-based soft magnetic powder, so as to provide a slurry having dispersed therein the Fe-based soft magnetic powder coated with a silicon oxide;
a step of subjecting the slurry having dispersed therein the Fe-based soft magnetic powder coated with a silicon oxide to solid-liquid separation, so as to provide Fe-based soft magnetic powder coated with a silicon oxide; and
a step of drying the Fe-based soft magnetic powder coated with a silicon oxide.

5. The method for producing silicon oxide-coated Fe-based soft magnetic powder according to claim 4, wherein the volume-based cumulative 50% particle diameter D₅₀ is 20 μm or more and 200 μm or less.

6. The method for producing silicon oxide-coated Fe-based soft magnetic powder according to claim 4, wherein the slurry in performing the adding step has a temperature of 10° C. or more and 70° C. or less.

7. The method for producing silicon oxide-coated Fe-based soft magnetic powder according to claim 4, wherein the slurry in performing the adding step has a temperature of 20° C. or more and 70° C. or less.

8. The method for producing silicon oxide-coated Fe-based soft magnetic powder according to claim 4, wherein the silicon oxide-coated Fe-based soft magnetic powder has a volume-based cumulative 50% particle diameter D₅₀ obtained by a laser diffraction particle size distribution measurement method of more than 5 μm and 200 μm or less.

9. The method for producing silicon oxide-coated Fe-based soft magnetic powder according to claim 4, wherein the silicon oxide-coated Fe-based soft magnetic powder has a volume-based cumulative 50% particle diameter D₅₀ obtained by a laser diffraction particle size distribution measurement method of 20 μm or more and 200 μm or less.
